(19) United States
(12) Patent Application Publication
(10) Pub. No.: US 2014/0116936 A1
(43) Pub. Date: May 1, 2014

(54) MANUFACTURING METHOD OF NANO POROUS MATERIAL AND NANO POROUS MATERIAL BY THE SAME

(71) Applicant: KOREA INSTITUTE OF SCIENCE AND TECHNOLOGY, Seoul (KR)

(72) Inventors: Seong Jin KIM, Gyeonggi-do (KR); Myoung Woon MOON, Seoul (KR); Kwang Ryeol LEE, Seoul (KR); Won Kyung SEONG, Seoul (KR); Wei DAI, Seoul (KR)

(73) Assignee: KOREA INSTITUTE OF SCIENCE AND TECHNOLOGY, Seoul (KR)

(21) Appl. No.: 13/973,013

(22) Filed: Aug. 22, 2013

(30) Foreign Application Priority Data
Oct. 26, 2012 (KR) 10-2012-0119810

(51) Int. Cl. B01D 69/02; B01D 67/00

(52) U.S. Cl. CPC B01D 69/02; B01D 67/00; B82Y 40/00
USPC 210/510.1; 427/569; 977/890; 977/902; 977/781

(57) ABSTRACT

The manufacturing method of nano porous material according to an example of the present invention comprises: a preparing step to prepare a substrate; and a manufacturing step to prepare nano porous material with a network structure in which nanoclusters are connected to each other using plasma deposition through over 300 mTorr of working pressure. Using the manufacturing method, it is possible to form a nano porous material having desired surface energy without formation of additional coating layer as well as pores distributed both within and on the surface of the nano porous material with only one deposition process.

### CROSS-REFERENCE TO RELATED APPLICATION

Pursuant to 35 U.S.C. §119(a), this application claims the benefit of earlier filing date and right of priority to Korean Application No. 10-2012-0119810, filed on Oct. 26, 2012, the contents of which is incorporated by reference herein in its entirety.

### BACKGROUND

1. Field of the disclosure

The following relates to a manufacturing method of nano porous material and nano porous material prepared by the same which has pores both distributed within the material and on its surface and containing the desired surface energy with only 1 time of deposition process.

2. Background of the disclosure

The porous material is a material having pores, which has been in the spotlight recently as it is necessary for applying to practical products that gas moves through the pores such as GDL(Gas Diffusion Layer) or desalination filter and products that user desired liquid moves through the pores such as filter of oil-water separator or super-hydrophobic/hydrophilic surface. As materials for this, materials that are less expensive and capable of mass supply such as nonwoven fabric and sponge have been used generally.

Besides, the movement of gas or liquid occurs in nanoscale or microscale, so it is known that the ability of the above mentioned materials to separate water and oil and their characteristics able to control product efficiency such as contact angle may depend on the size of pores and the efficiency is higher in nanoscale than that in microscale. For instance, as the filter of oil-water separator tends to have lower filter efficiency in using only micro-pores formed on a non-woven fabric, it is possible to enhance the efficiency by establishing nanostructure on the non-woven fabric additionally [Ref.: Bongsu Shin, et al., Soft matter 8 (2012) 1817-1823.].

However, these nanostructures (nanopillar, nano dot, and nanowire) have been established only on the surface of material, so it is not porosity in a strict sense that the pores are established even in inside of material, but partial porosity having pores established in a part of the material (usually on the surface). In addition, although most applied products require a material with low surface energy, it is difficult to make a material have low surface energy as well as nanostructure . Therefore, in order to prepare a nanostructured material with low surface energy, there is some troublesomeness that coating another specific material with lower surface energy is required after establishing nanostructure on a material.

In order to solve this problem, it is intended to suggest a method for preparing a nano porous material having both desired surface energy and porous nanostructure in the following.

### SUMMARY OF THE DISCLOSURE

An objective is to provide a manufacturing method of nano porous material and a nano porous material by the same, which can establish a nano porous material not only having pores distributed both on its surface and in its inside with only one time of deposition through simple method but also having desired surface energy without formation of additional coating layer.

In order to achieve the objective, a manufacturing method of nano porous material according to an example of the various configurations comprises: a preparing step to prepare a substrate; and a manufacturing step to prepare nano porous material on the substrate through plasma deposition under the condition of deposition pressure as equal to or more than 300 mTorr, wherein the nano porous material comprises a network structure in which nanoclusters are connected to each other.

The plasma deposition may be performed at the voltage of −500 V˜−1000 V.

The plasma deposition may be applied with an inflow gas comprising hydrocarbon-based gas.

The hydrocarbon-based gas may be one selected from the group consisting of acetylene (C₂H₂), methane (CH₄), benzene (C₆H₆), hexamethyldisiloxane (C₆H₁₈OSi₂), and combinations thereof.

The pores of the nano porous material may be distributed within and on the surface of the nano porous material.

The diameter of the pores distributed within the nano porous material may be in the range of 10˜70 nm and the diameter of the nanoclusters is in the range of 10˜50 nm.

The thickness of the nano porous material may be equal to or less than 1000 μm.

The inflow gas may further comprise a functional gas selected from the group consisting of carbon tetrafluoride (CF₄), argon (Ar), nitrogen (N₂), silane (SiH₄), and combinations thereof.

The substrate may contain one selected from the group consisting of ceramic, metal, and plastic.

A nano porous material according to another example of the various configurations has a network structure in which nanoclusters are connected to each other.

The nano porous material may comprise pores which are distributed within and on the surface of the nano porous material.

The diameter of the pores distributed within the nano porous material may be in the range of 10˜70 nm and the diameter of the nanoclusters may be in the range of 10˜50 nm.

The thickness of the nano porous material may be equal to or less than 1000 μm.

A manufacturing method of a filter according to another example of the various configurations comprises the manufacturing method of the nano porous material.

A manufacturing method of super-hydrophobic surface according to another example of the various configurations comprises the manufacturing method of the nano porous material.

Other features and aspects will be apparent from the following detailed description, the drawings, and the claims.

### BRIEF DESCRIPTION OF THE DRAWINGS

FIG. 1 is a conceptual map showing an example of the manufacturing method of nano porous material.

FIG. 2 shows SEM (Scanning Electron Microscope) surface images of the nano porous materials manufactured by Comparative Example 1 & 2 and Example 1˜3. The images show nano porous materials manufactured by different deposition pressures such as (a) 100 (Comparative Example 1), (b) 200 (Comparative 2), (c) 300 (Example 1), (d) 400 (Example 2), (e) 500 (Example 3) mTorr.

FIG. 3 shows SEM (Scanning Electron Microscope) sectional images of the nano porous materials manufactured by Comparative Example 1 & 2 and Example 1˜3. The images show nano porous materials manufactured by different deposition pressures such as (a) 100 (Comparative Example 1), (b) 200 (Comparative 2), (c) 300 (Example 1), (d) 400 (Example 2), (e) 500 (Example 3) mTorr.

FIG. 4 shows TEM (Transmission Electron Microscope) images of the nano porous material manufactured by 500 mTorr of deposition pressure according to the Example 3.

FIG. 5 is a graph of pore size measured by physical absorption using nano porous coating of Example 3 manufactured by 500 mTorr of deposition pressure.

FIG. 6 shows SEM surface images of the nano porous materials manufactured by 500 mTorr of deposition pressure according to the Example 4˜7. The image show nano porous materials manufactured with different flow ratio of carbon tetra fluoride such as (a) 5/15 (Example 4), (b) 10/10 (Example 5), (c) 15/5 (Example 6), and (d) 16/4 (Example 7) as inflow gas.

FIG. 7 shows SEM surface images of the nano porous materials manufactured on different substrates such aluminum (Example 8), silicone (Example 9), and polyethylene (Example 10) by 500 mTorr of deposition pressure according to the Example 8˜10.

### DETAILED DESCRIPTION

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will is become apparent to those skilled in the art from the detailed description.

Plasma deposition technique means a technique to form a thin film using plasma state by supplying electric energy at high frequency (usually radio frequency) to desired gas. This plasma state may be understood as a state of highly activated particles, wherein the particles activated by artificial bias-voltage or self bias-voltage put into the certain surface with kinetic energy. When the particles are deposited on the certain surface, it is regarded as deposition of thin film. This plasma deposition technique has a property that the particles put into the surface with high kinetic energy, so highly compressed thin film is formed. In other words, general plasma deposition techniques render highly dense film formed, so this plasma deposition technique is usually used in forming highly dense films such as anti-abrasion coating, anti-oxidation coating, or oxygen barrier coating. However, it is a material having a quite contrary property to the nano porous material intended to manufacture in the present invention.

Inventors of the present invention completed the invention by finding that when performing plasma deposition using extremely high deposition pressure, not low pressure condition used in general plasma deposition, nano porous material is formed.

The manufacturing method of nano porous material according to another example of the various configurations comprises: a preparing step to prepare a substrate; and a manufacturing step to prepare the nano porous material.

The manufacturing step may include a process to form a thin film on the substrate using plasma deposition, wherein the deposition pressure is set to equal to or more than 300 mTorr. The nano porous material may comprise a network structure in which nanoclusters, clusters in nanoscale, are connected to each is other, and it is possible to form pores of the nano porous material are distributed within and on the surface of the nano porous material.

Conventional plasma deposition has been used for manufacturing thin film requiring higher density and as the particles deposited by it have higher residual stress, so it has formed materials with higher density that seldom peels off from the substrate (board). However, nothing is known about deposition of particles with extremely low kinetic energy.

The disclosure provides a method to manufacture nano porous material by depositing particles with extremely low kinetic energy in the process of plasma deposition. It was identified that the plasma deposition at extremely high deposition pressure over 200 or 300 mTorr rather than conventional deposition pressure was effective in order to render the particles have extremely low kinetic energy. When forming thin film using plasma deposition technique at the extremely high deposition pressure, there is a characteristic that mean free path of the deposited particles are reduced greatly. It is understood that this is because the activated particles collide with other activated particles around them and lose their kinetic energy considerably. Thus, the particles are deposited in state of having extremely low kinetic energy when they are deposited on the substrate (board).

The deposition pressure may be equal to or more than 300 mTorr, may be 300˜500 mTorr, and preferably may be 400˜500 mTorr. When the deposition pressure exceeds 500 mTorr, there is a risk that the plasma may become unstable and when the deposition pressure is below 300 mTorr, the porous film may not be formed. Therefore, it is capable of stable formation of the nano porous material within the range of deposition pressure. In addition, the deposition pressure may be 400˜500 mTorr preferably and it is possible to manufacture nano porous material with excellent specific surface area within the pressure range.

In other words, reduction of kinetic energy of particles activated in the plasma deposition process induces reduction of biding energy among the particles, so it is possible to manufacture a material with nano pore structure through simple process without additional thermal treatment or annealing to the manufactured material.

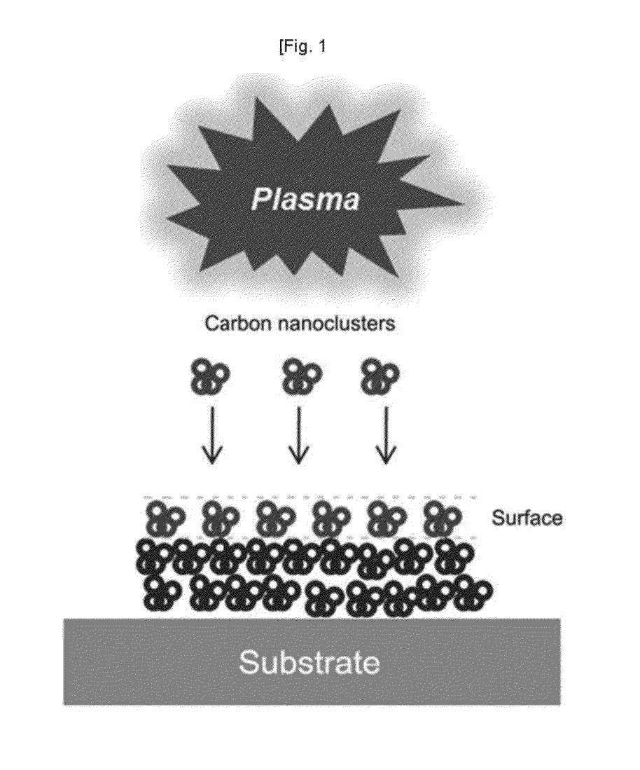

FIG. 1 is a conceptual map showing an example of the manufacturing method of nano porous material. As shown in FIG. 1, it is suggested that when performing plasma deposition with the manufacturing method, several particles gather together to form nanoclusters, these clusters are connected together to form a network, and nano porous material is formed.

The nano porous material may comprise pores which are distributed within and on the surface of the nano porous material. The nano porous material can comprise pores both within the material and on its surface evenly without necessity of removing a part of the material of therein, or additional nanostructure formation or annealing process once the particles are deposited to form a thin film. This is because the nano particles that already have cluster form and low kinetic energy during the manufacturing process are deposited to form nano porous material, different from conventional methods for manufacturing nano porous material.

The diameter of the pores distributed within the nano porous material may be in the range of 10˜70 nm and the diameter of the nanoclusters may be in the range of 10˜50 nm. When the nano porous material is manufactured within the range of pore size and nanocluster's diameter, it is possible to improve performance of products applying the nano porous material in comparison with products applying conventional porous material having larger pore size in microscale due to more fine nano pores.

The plasma deposition may be performed at the voltage of −500 V˜−1000 V. When the plasma deposition is done within the voltage range, it is possible to form stable plasma even at the high pressure condition of the present invention.

For the inflow gas used in the plasma deposition any gas applicable to plasma deposition technique can be applied and principally hydrocarbon-based gases can be applied widely.

When forming nano porous material through plasma deposition process using hydrocarbon-based gas as inflow gas, it is possible to form a film type carbon material containing hydrogen in part.

This nano porous carbon material may have excellent biocompatibility, may be easy to grant new property through combination (such as, for example, doping) with other elements, may have unique and useful properties according to its structure such as, for example, carbon nano tube or graphene.

In case of applying a hydrocarbon-based gas as the inflow gas, a material comprising carbon nanoclusters may be formed as a nano porous material, wherein the material may comprise hydrogen.

The hydrocarbon-based gas is one selected from the group consisting of acetylene (C₂H₂), methane (CH₄), benzene (C₆H₆), hexamethyldisiloxane (C₆H₁₈OSi₂), and combination thereof and preferably may be acetylene (C₂H₂).

The inflow gas further comprises functional gas which may be one selected from the group consisting of carbon tetrafluoride (CF₄), argon (Ar), nitrogen (N₂), silane (SiH₄), and combination thereof. The functional gas may grant functionalities such as controlling the pore size, which can simplify the manufacturing process further because it is possible to grant additional functionalities to the nano porous material manufactured through simple process of plasma deposition by comprising functional gas in addition to inflow gas.

Especially, when mixing the carbon tetrafluoride gas as the functional gas, it is possible to control diameter size of the nanoclusters and pore size comprised in the nano porous material.

The carbon tetrafluoride gas may be comprised in the inflow gas in the ratio of 1:3˜4:1 with the hydrocarbon-based gas. In this case, it is possible to control the pore size comprised in the nano porous material in the scale from several ten to several hundred nano and the diameter of nanoclusters in the scale from several to several ten nano.

Thickness of the nano porous material may be equal to or less than 1000 μm, may be 0.1˜1000 μm, and may be equal to or more than 1000 μm. In addition, thickness of the nano porous material may be 500˜1000 nm.

Although the nano porous material comprises nano pores which are distributed within and on the surface of the nano porous material, it is possible to manufacture the nano porous material with considerable thickness equal to or more than 1000 on when using the manufacturing method of the disclosure and it is possible also if necessary to control the thickness of the nano porous material to appropriate scale by adjusting deposition thickness of the nano porous material.

There is no specific limitation on the substrate (board) material, which is one of merits of the invention. In other words, the substrate used in the invention may be one selected from ceramic, metal, and plastic and it is possible to accomplish deposition of the nano porous material without restriction on shape or is material of the substrate. It is considered that this is because the residual stress inside of the nano porous material formed by deposition of particles with extremely low kinetic energy is extremely low.

According to the manufacturing method of nano porous material of the disclosure, it is possible to manufacture nano porous material having nano pores distributed both within the material and on its surface with simple process. This method can simplify the manufacturing process of nano porous material dramatically in aspects that it is possible to form pores without additional thermal treatment or annealing process and manufacture the nano porous material having pores distributed both within the material and on its surface with only one time of plasma deposition process. In addition, it is possible also to form nano porous material with considerable thickness using the plasma deposition process.

A nano porous material according to another example of the various configurations has a network structure in which nanoclusters are connected to each other. It is possible to manufacture the nano porous material comprising nanoscale pores distributed both within the material and on its surface by rendering nano particles with extremely low kinetic energy connected each other during their deposition process.

In addition, as the nano porous material is manufactured by deposition of particles with extremely low kinetic energy, residual stress of the formed nano porous material is extremely low, so it is possible to form the nano porous material without limitation on shape or material of the substrate.

The nano porous material may have a shape of thin film.

The diameter of the pores distributed within the nano porous material may be in the range of 10˜70 nm and the diameter of the nanoclusters may be in the is range of 10˜50 nm.

The thickness of the nano porous material may be 0.1˜1000 μm, may be equal to or more than 1000 μm, and may be 500˜1000 nm. The nano porous material may be formed by controlling the thickness and may have considerably high thickness, equal to or more than 1000 μm. As the thickness of the nano porous material can be controlled as occasion demands, it is possible to broaden its application range.

A manufacturing method of a filter according to another example of the various configurations comprises the manufacturing method of the nano porous material. Using the manufacturing method of the nano porous material, it is possible to manufacture a filter by controlling pore size with simple and easy process and the filter can be applied as a filter of oil-water separator or a GDL(Gas diffusion layer) filter.

A manufacturing method of super-hydrophobic surface according to another example of the various configurations comprises the manufacturing method of the nano porous material. The super-hydrophobic surface can maximize effects of the super-hydrophobicity by nanoscale porous structure rather than microscale structure.

### EFFECTS

The manufacturing method of nano porous material according to the present invention can form the porous material having pores distributed even in its inside as well as on its surface with only one deposition process. In addition, it can form the porous material having desired surface energy without necessity of is formation of additional coating layer. In other words, it does not need additional annealing or additional treatments such as heat treatment for formation of pores and can form the nano porous material comprising pores distributed both in its inside and on its surface as well as having intended surface energy with simple process of only one plasma deposition. Furthermore, the nano porous material of the present invention can laminate materials with excellent porosity without limitation on the substrate and it is possible to manufacture the nano porous material with considerably high thickness, equal to or more than 1000 μm.

### Comparative Example 1 and Comparative Example 2

Acetylene gas (C₂H₂) was introduced as 20 sccm of flux into the plasma reactor and deposition process was performed to the substrate.

In the deposition process, rf-power was maintained to 600 W and bias-voltage was maintained to −600 V constantly. The thin film obtained with 100 mTorr of deposition pressure was referred to Comparative Example 1 and the thin film obtained with 200 mTorr of deposition pressure was referred to Comparative Example 2.

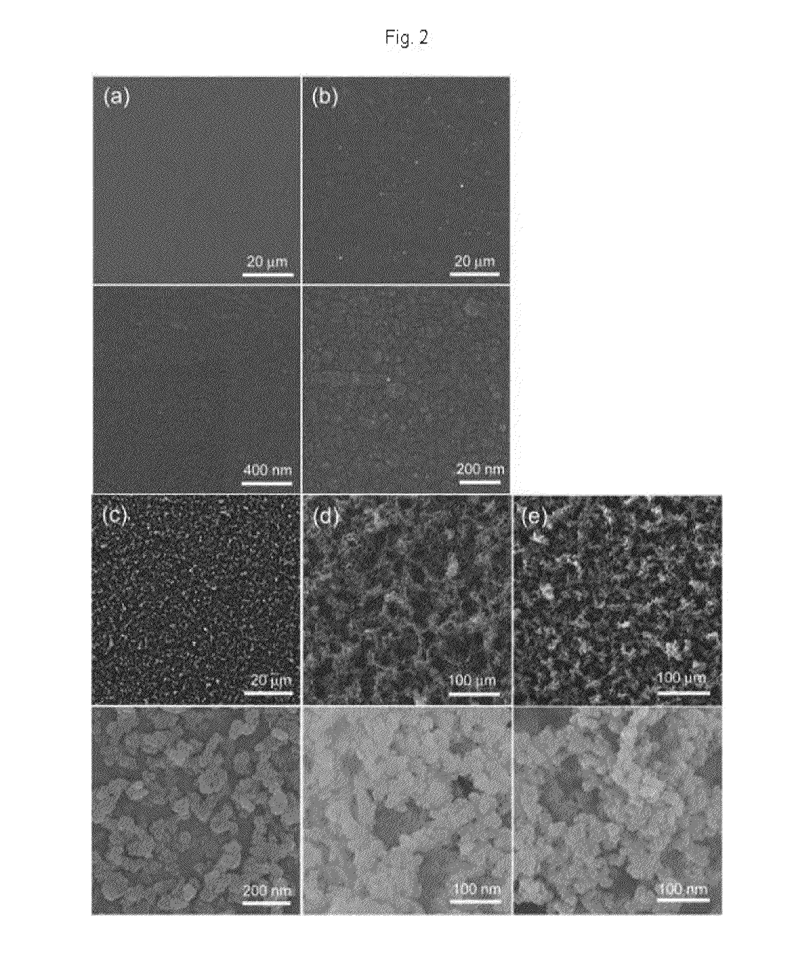

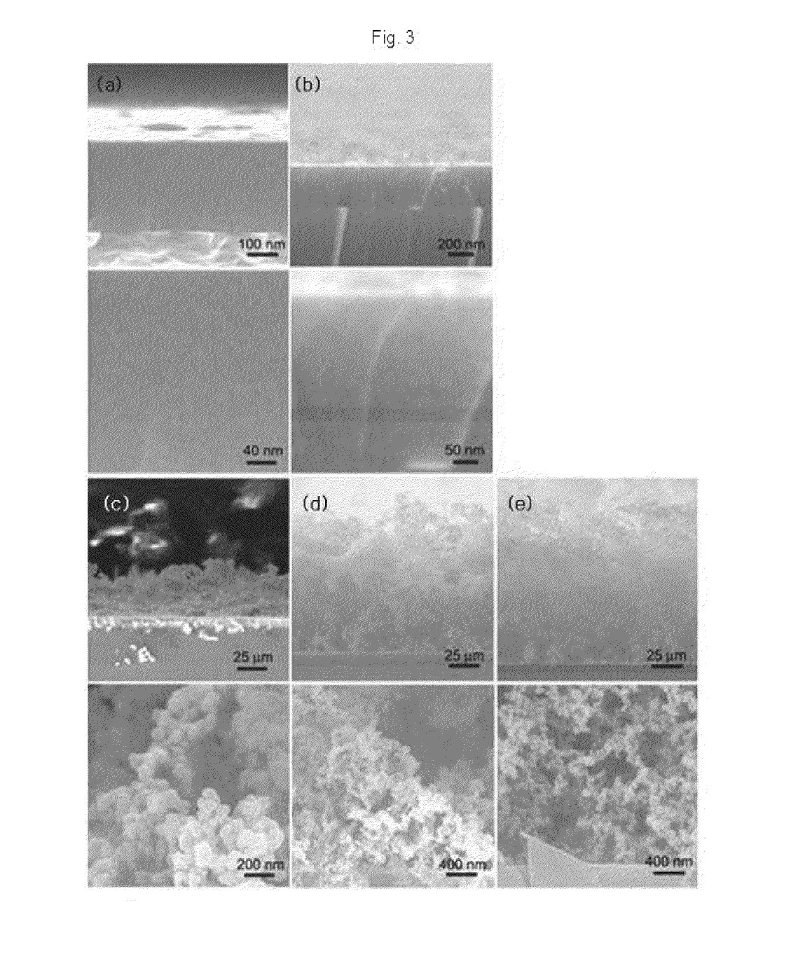

The fine structures of Comparative Example 1 and Comparative Example 2 were observed with SEM and the images were displayed as FIG. 2 (a) and (b). In addition, the fine structures of film cross section of Comparative Example 1 and Comparative Example 2 were observed with SEM and the images were displayed as FIG. 3 (a) and (b).

### Example 1˜Example 3

Acetylene gas (C₂H₂) was introduced as 20 sccm of flux into the plasma reactor and deposition process was performed to the substrate.

Same to the Comparative Example 1 and Comparative Example 2, the rf-power was maintained to 600 W and bias-voltage was maintained to −600 V constantly. Thin films of Example 1, 2, and 3 were manufactured changing the deposition pressure to 300, 400, and 500 mTorr respectively.

The fine structures of Example 1˜3 were observed with SEM and the images were displayed as FIG. 2 (c)˜(e). In addition, the fine structures of film cross section of Example 1˜3 were observed with SEM and the images were displayed as FIG. 3 (c)˜(e). As shown in the image of FIG. 2 and FIG. 3, it was identified that nano porous structure was observed apparently in the thin film manufactured by the Example 1˜3 in comparison with the Comparative Example 1 and 2.

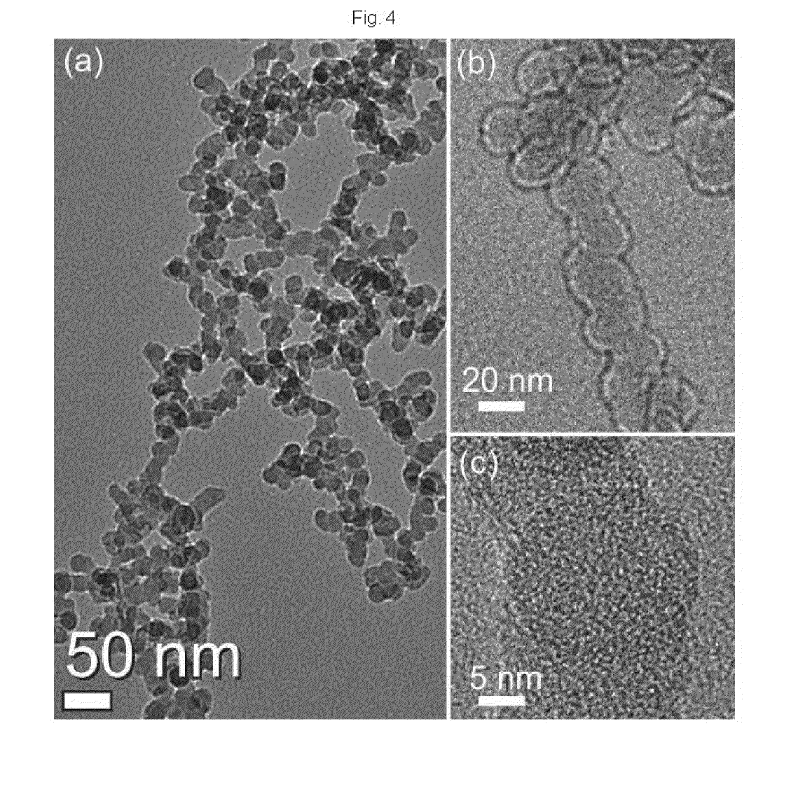

FIG. 4 shows TEM images of thin film manufactured by the Example 3. As shown in the FIG. 4 it was identified that nanoclusters with several ten nanometer of diameter were connected each other to form a network.

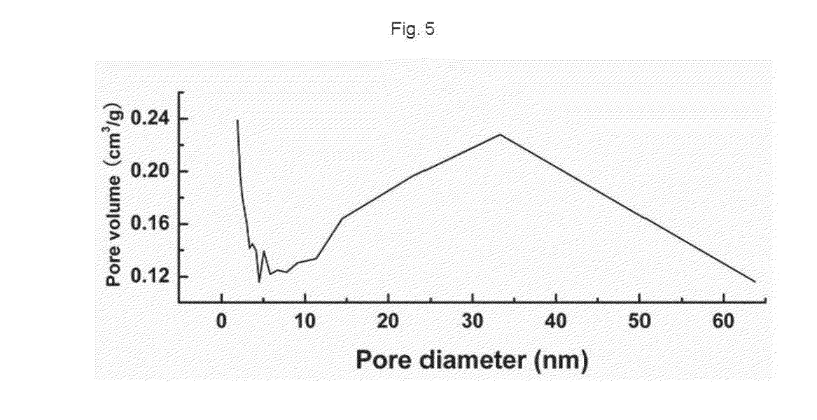

In order to measure the pore size of thin film manufactured by the Example 3, physical absorption method using nitrogen gas was used and the results were displayed in FIG. 5. As shown in the FIG. 5, it was identified that in the thin film of the Example 3, pores with various sizes from very tiny sized pores approaching about 10 nm to nanoscale pores approaching about 60 nm were formed.

### Example 4˜Example 7

The deposition process was performed in the plasma reactor, introducing inflow gas as 20 sccm of flux to the substrate. Same to the Comparative Example 1 and 2 and Example 1˜3, the rf-power was maintained to 600 W and bias-voltage was maintained to −600 V in the deposition process constantly. The same deposition pressure, 500 mTorr, was applied. However, the inflow gas was applied by mixing a functional gas, carbon tetrafluoride (CF₄) with the acetylene gas (C₂H₂) and the thin films of Example 4, 5, 6, and 7 were manufactured by using different flow ratio (CF₄/C₂H₂, volume ratio) such as (a) 5/15, (b) 10/10, (c) 15/5, and (d) 16/4.

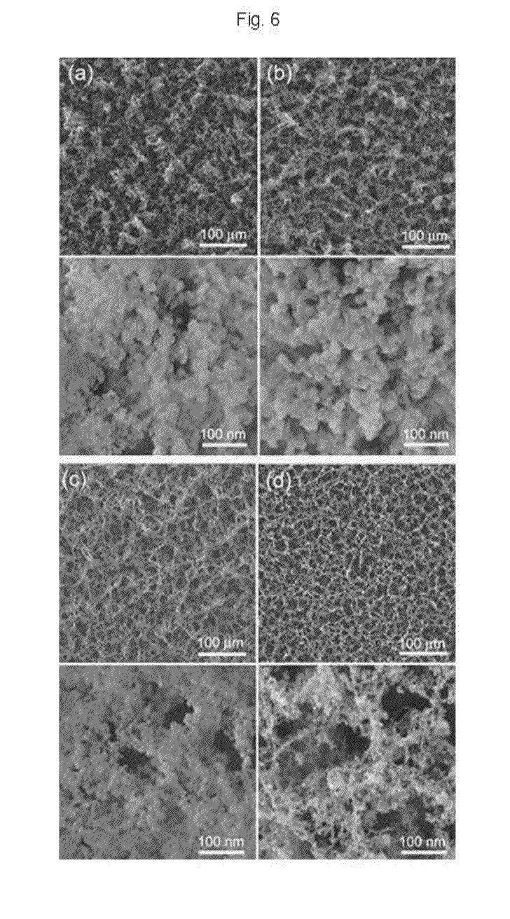

The surface structure of thin films manufactured by the Example 4˜7 were observed with SEM and the images were displayed in FIG. 6. As shown in the FIG. 6, it was possible to control size of the pores and diameter of the nanoclusters by a ratio of mixing the hydrocarbon-based gas, acethylene gas, and the functional gas, carbon tetrafluoride. With this, it was identified that when mixing more amount of the functional gas, carbon tetrafluoride, more dense nanoclusters were formed.

### Example 8˜Example 10

The deposition process was performed in the plasma reactor, introducing the inflow gas, acetylene gas (C₂H₂), as 20 sccm of flux to the substrate. Same to the Comparative Example 1 and 2 and Example 1˜7, the rf-power was maintained to 600 W and bias-voltage was maintained to −600 V in the deposition process constantly. The same deposition pressure, 500 mTorr, was applied.

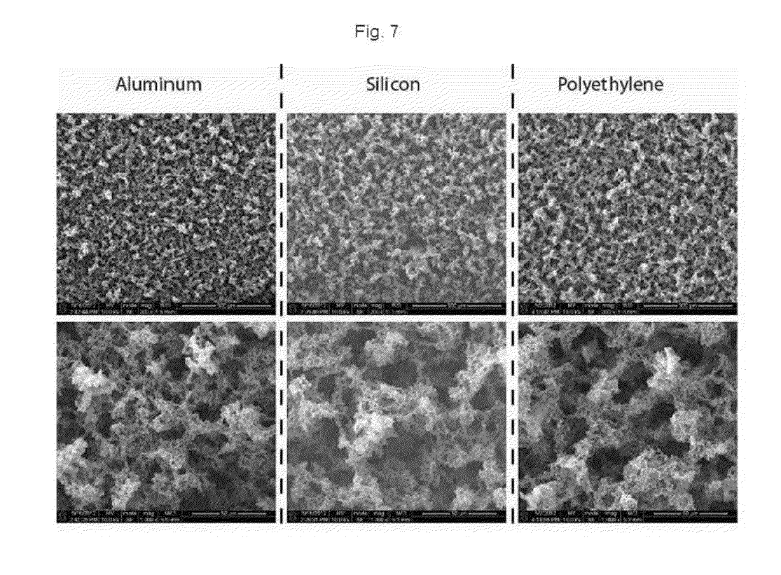

However, the nano porous materials of the Example 8, 9, and 10 were manufactured, changing the substrates to aluminum which is a metal, silicone which is a ceramic, and polyethylene which is a plastic. Their fine surface structures were observed with SEM and the images were displayed in FIG. 7. As shown in the FIG. 7, it was identified that similar nano porous thin films were formed regardless of substrate types such as metal, ceramic, or plastic. It is considered that this is because due to extremely low kinetic energy of the deposited materials, the residual stress inside of the thin film is extremely low, so the formed thin film is not unstable regardless of the substrate material.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A manufacturing method of nano porous material comprising steps of:
a preparing step to prepare a substrate; and
a manufacturing step to prepare nano porous material on the substrate through plasma deposition under the condition of deposition pressure as equal to or more than 300 mTorr, wherein the nano porous material comprises a network structure in which nanoclusters are connected to each other.

2. The manufacturing method of claim 1, wherein plasma deposition is performed at the voltage of −500 V˜−1000 V.

3. The manufacturing method of claim 1, wherein the plasma deposition is applied with an inflow gas comprising hydrocarbon-based gas.

4. The manufacturing method of claim 3, wherein the hydrocarbon-based gas is one selected from the group consisting of acetylene (C₂H₂), methane (CH₄), benzene (C₆H₆), hexamethyldisiloxane (C₆H₁₈OSi₂), and combinations thereof.

5. The manufacturing method of claim 1, wherein pores of the nano porous material are distributed within and on the surface of the nano porous material.

6. The manufacturing method of claim 5, wherein the diameter of the pores distributed within the nano porous material is in the range of 10˜70 nm and the diameter of the nanoclusters is in the range of 10˜50 nm.

7. The manufacturing method of claim 1, wherein the thickness of the nano porous material is equal to or less than 1000 μm.

8. The manufacturing method of claim 3, wherein the inflow gas further comprise a functional gas selected from the group consisting of carbon tetrafluoride (CF₄), argon (Ar), nitrogen (N₂), silane (SiH₄), and combinations thereof.

9. The manufacturing method of claim 1, wherein the substrate contains one selected from the group consisting of ceramic, metal, and plastic.

10. Nano porous material comprising a network structure in which nanoclusters are connected to each other.

11. The nano porous material of claim 10, wherein the nano porous material comprises pores which are distributed within and on the surface of the nano porous material.

12. The nano porous material of claim 10, wherein the diameter of the pores distributed within the nano porous material is in the range of 10˜70 nm and the diameter of the nanoclusters is in the range of 10˜50 nm.

13. The nano porous material of claim 10, wherein the thickness of the nano porous material is equal to less than 1000 or μm.

14. A manufacturing method of a filter comprising the manufacturing method according to claim 1.

15. A manufacturing method of super-hydrophobic surface comprising the manufacturing method according to claim 1.
